(19) United States
(12) Patent Application Publication
(10) Pub. No.: US 2019/0021134 A1
(43) Pub. Date: Jan. 17, 2019

(54) USER PLANE OPTIMIZATION FOR NARROWBAND INTERNET OF THINGS

(71) Applicant: NOKIA TECHNOLOGIES OY, Espoo (FI)

(72) Inventors: Yanji ZHANG, Beijing (CN); Jussi-Pekka KOSKINEN, Oulu (FI); Sean KELLEY, Hoffman Estates, IL (US); Hannu Petri HIETALAHTI, Kiviniemi (FI)

(73) Assignee: Nokia Technologies Oy, Espoo (FI)

(21) Appl. No.: 16/068,186

(22) PCT Filed: Jan. 8, 2016
(86) PCT No.: PCT/CN2016/070502

§ 371 Date: Jul. 5, 2018

(51) Int. Cl. H04W 76/38; H04W 76/27; H04W 36/00; H04W 76/19

(52) U.S. Cl. CPC H04W 76/38; H04W 76/19; H04W 36/0033; H04W 76/27

(57) ABSTRACT

A user equipment (UE) and a network access node (eNB or CIoT-BS) each store in their local memory the UE's context. Automatically upon a designated communication between them a timer is initiated that indicates the UE context is valid. For transitioning the UE from an idle to a connected mode, there is a selection between a first and a second procedure and this selection is based on the timer and on at least one other prescribed validity criterion (for example, context validity area, radio conditions or CE level). Data is then sent or received on a radio connection that is obtained via the selected first or second procedure, where only one of the first and second procedures utilizes the stored UE context. During that procedure, in an embodiment the UE can send to the CIoT-BS an indication that it has the stored UE context.

### TECHNOLOGICAL FIELD

The described invention relates to wireless communications, and more particularly to establishing radio access for small data packets such as may become more common in cellular Internet of Things (CIoT) scenarios.

### BACKGROUND

Towards the development of communications protocols for the Internet of Things (IoT) the 3^{rd} Generation Partnership Project (3GPP) has approved a new Release 13 work item. The objective is to specify a radio access for cellular narrowband IoT. To a great extent this is based on a variant of evolved UMTS radio access (E-UTRA, also known as Long Term Evolution or LTE). This work item addresses improved indoor coverage, support for a very large number of low throughput devices characterized by low sensitivity to communication delays, very low cost and low device power consumption, and an optimized network architecture.

There is also research into architecture enhancements to support ultra-low complexity, power constrained, and low data-rate IoT devices and these enhancements are to support a highly efficient handling of frequent and infrequent small data transmissions. Traditional cellular signaling was developed under the assumption that there would be relatively large volumes of data transmitted, and so the signaling overhead to set up a radio resource control (RRC) connection was not large in comparison to the data to be communicated. With the advent of ‘always-on’ applications that run continuously in the background, the volume of data exchanged became much smaller but the solution was often to adapt previous regimens to have larger inactivity periods in between data transmissions rather than re-structure the entire network negotiation for assigning a data channel. A more fundamental re-thinking is required for IoT since there can be quite large latency periods between active data transmissions to and from many IoT devices. Conventionally, IoT using cellular radio spectrum is referred to as cellular IoT (CIoT).

Some such proposals are outlined in 3GPP TR 23.720 v1.1.0 (2015-10). Solution 2 concerns infrequent small data transmissions using a pre-established network access stratum (NAS) security. For the case of a mobile originated (MO) small data transmission, the mobile device (user equipment or UE) performs an attach procedure, establishes an RRC connection after requesting its access stratum (AS) context and sends a NAS message (in a new format) that carries the small data packet in an encrypted information element (IE). The cellular serving gateway node (C-SGN) obtains a key, a sequence number, and an identifier assigned to the UE from an unencrypted portion of this NAS message and uses these to identify the UE's security context which it uses to decrypt the small data packet for forwarding towards its intended recipient.

That same 3GPP TR 23.720 document also details a Solution 18 which is a user-plane solution for setting up the RRC connection. Solution 18 includes a RRC suspend procedure whereby the UE retains its access stratum (AS) context (also commonly referred to as the UE context) while in the RRC-IDLE mode, and similarly a RRC resume procedure. FIG. 1 illustrates this RRC suspend procedure and is reproduced from FIG. 6.18.1.3-1 of 3GPP TR 23.720 v1.1.0. For Solution 18 the network mobility management entity (MME) and eNB (the E-UTRA network base station) as well as the UE itself store the UE's context along with the bearer related information; the AS or UE context includes the UE's security context.

The potential advantage of Solution 18 is that the UE would not need to request its UE context to move back to the RRC-CONNECTED mode when it has a need to send a small data packet. While this would be efficient, it relies entirely on the UE and the network both having the correct knowledge of the UE context availability. If this assumption does not hold an undesired signaling exchange might be necessary to get the context synchronized. For example, if the UE initiates the RRC connection resume procedure towards a eNB which does not have the valid UE context, resolving the disparity by using either the normal RRC connection setup procedure or the context fetch procedure over the X2 interface (eNB to eNB) would represent a drastic increase in signaling overhead and result in access delay.

On the other hand, the memory requirement would be significant if the eNB were to maintain the UE context for a very large number of UEs under its coverage, and even more so if the eNB were to store the context of UEs that have moved outside of that eNB's signaling area.

### SUMMARY

According to a first aspect of these teachings there is a method comprising: storing in a local memory a user equipment (UE) context; automatically upon a designated communication between a user equipment and a network access node initiating a timer that indicates the UE context is valid; selecting between a first procedure and a second procedure for transitioning the user equipment from an idle mode to a connected mode based on the timer and on at least one other prescribed validity criterion; and thereafter sending or receiving data on a radio connection that is obtained via the selected first or second procedure, where only one of the first and second procedures utilizes the stored UE context.

According to a second aspect of these teachings there is an apparatus comprising at least one memory storing a computer readable program, and at least one processor. In this second aspect the at least one processor, with the at least one memory and the computer readable program, cause the apparatus to at least: store in the at least one memory a user equipment (UE) context; automatically upon a designated communication between a user equipment and a network access node, initiate a timer that indicates the stored UE context is valid; select between a first procedure and a second procedure for transitioning the user equipment from an idle mode to a connected mode based on the timer and on at least one other prescribed validity criterion; and thereafter send or receive data on a radio connection that is obtained via the selected first or second procedure, where only one of the first and second procedures utilizes the stored UE context.

According to a third aspect of these teachings there is a memory storing a program of computer readable instructions that when executed by at least one processor cause a host communication device to at least: store in a local memory of the communication device a user equipment (UE) context; automatically upon a designated communication between a user equipment and a network access node, initiate a timer that indicates the stored UE context is valid; select between a first procedure and a second procedure for transitioning the user equipment from an idle mode to a connected mode based on the timer and on at least one other prescribed validity criterion; and thereafter send or receive data on a radio connection that is obtained via the selected first or second procedure, where only one of the first and second procedures utilizes the stored UE context.

According to a fourth aspect of these teachings there is an apparatus comprising memory means, timing means, selecting means and radio means. The memory means is for storing a user equipment (UE) context. The timing means is for indicating the stored UE context is valid, where said timing means is initiated automatically upon a designated communication between a user equipment and a network access node. The selecting means is for selecting between a first procedure and a second procedure for transitioning the user equipment from an idle mode to a connected mode, and this selecting is based on the timer and on at least one other prescribed validity criterion. The radio means is for sending and/or receiving data on a radio connection that is obtained via the selected first or second procedure, where only one of the first and second procedures utilizes the stored UE context.

According to a fifth aspect of these teachings there is a method comprising: sending a radio resource radio signaling for suspending a radio connection; storing in a local memory a user equipment (UE) context; and the said radio resource connection signaling comprising at least one of context validity time and context validity area.

According to a sixth aspect of these teachings there is an apparatus comprising at least one memory storing a computer readable program, and at least one processor. In this second aspect the at least one processor, with the at least one memory and the computer readable program, cause the apparatus to at least: send a radio resource connection signaling for suspending a radio connection; store in a local memory a user equipment (UE) context; and the said radio resource connection signaling comprising at least one of context validity time and context validity area.

### BRIEF DESCRIPTION OF THE DRAWINGS

FIG. 1 is a prior art signaling diagram reproduced from FIG. 6.18.1.3-1 of 3GPP TR 23.720 v1.1.0 and showing the RRC suspend procedure contemplated for CIoT purposes.

FIG. 2 is a signaling diagram illustrating signaling between the network access node, the UE, and other related network nodes according to certain embodiments of these teachings.

FIG. 3 is a process flow diagram summarizing certain of the above teachings from the perspective of the UE and/or of the network access node.

FIG. 4 is a high level schematic block diagram illustrating certain apparatus/devices that are suitable for practicing certain of these teachings.

### DETAILED DESCRIPTION

The Solution 18 detailed at 3GPP TR 23.720 v1.1.0 reuses the information from a previous RRC connection for subsequent RRC connection setup in order to reduce the signaling overhead and the associated processing load in the network. This signaling overhead reduction is realized by introduction of the RRC Suspend and RRC Resume options, and the corresponding introduction of a modified UE behavior in the new CIoT Idle state where the relevant AS information is always stored at the UE's transition to the IDLE mode, that storing is triggered by the RRC Suspend procedure, and the stored AS information is re-used for a subsequent connection setup by this new type of UE.

As mentioned above it may arise that the UE and/or the network have incorrect knowledge of the UE context availability, either of which would lead to an additional and undesirable signaling exchange to resolve the UE context disparity, increasing the signaling overhead and adding delay to getting the UE re-established with a RRC connection. Embodiments of these teachings that specifically adapt Solution 18 to resolve this concern proceed from the following assumptions.
A. The UE may retain the AS context/UE context in RRC_IDLE mode for the user-plane (UP) solution (this particular RRC IDLE mode may come to be known by a different name, enhanced RRC IDLE or the like).
B. A RRC Connection Suspend type of procedure is used to transition from the RRC_CONNECTED to the above RRC_IDLE state during which the UE stores the AS context/UE context.
C. The UE's security is continued through the RRC Suspend and RRC Resume procedures, so the UE context does not change.
D. A RRC Resume type of procedure is used to transition from the above RRC_IDLE state to the RRC_CONNECTED state, and the previously stored information in the UE as well as in the network (specifically in the eNB) is utilized to resume that RRC connection.
E. The RRC Suspend type of procedure and the RRC Resume type of procedure may be new procedures with new messages, or either or both of these may be implemented using new information elements in existing LTE procedures.
F. In the message to resume the RRC Connection the UE provides an identifier to be used by the eNB to access the stored information that is required to resume the RRC Connection.
G. If the RRC Resume type of procedure fails (for example, if the AS context/UE context is not present), the UE may initiate a new RRC connection setup though this may be done via traditional RRC establishment procedures or some abbreviated or optimized form thereof.
H. The data radio bearer (DRB) used for the RRC connection may be multiplexed with the connection resume request, if the size of the granted transport block permits such multiplexing.
I. The data radio bearer (DRB) is established in the narrowband IOT.
J. For the user-plane solution, the packet data convergence protocol (PDCP) header compression may be used for interne protocol (IP) type traffic.

To avoid problems that may arise when the UE and/or the network have incorrect knowledge of the UE context availability across a RRC Suspend and RRC Resume exchange, embodiments of these teachings introduce what is herein referred to as a context validity time and context validity area. These are first introduced in the RRC release procedure that is used for suspending the UE's RRC connection. Based on this information about the context validity time and the context validity area, the UE is able to determine whether RRC resume type of procedure can succeed in the present area at the present time, or should a normal RRC connection setup procedure (service request) be performed instead when the UE has data to send/receive such as an infrequent small data packet. More specific embodiments of these teachings further detail certain UE-specific conditions for a context availability indication, which is one indication on which the UE bases its decision to attempt the RRC Resume type of procedure.

Both the UE and the CIoT base station (eNB) maintain their own context validity timer which run synchronously in the ideal but independently of one another. In one particular embodiment this timer is started upon dedicated signalling from the network, such as for example when the UE receives any of the following: a RRC connection suspend message, a RRC connection resume message, a RRC connection reconfiguration message, a RRC connection setup message, and a RRC connection release message. This timer may in an embodiment also be started upon a data transmission from the network. The stored UE context is not valid (released, suspended, deleted from the local memory, or stopped from being used) upon the expiration of this timer. Of course this can be overridden in that the stored UE context can be released even while the timer is still running (not yet expired) upon specific instructions to do so that the network may broadcast or communicate to the UE via dedicated signalling. Once the timer is initiated, in certain embodiments this timer is then stopped upon broadcast or dedicated signalling from the network, or upon initiation of the control plane solution (for example, Solution 2 of 3GPP TR 23.720 which is a signalling-only solution that does not require setting up a packet data network PDN/IP connection during the attach procedure), or upon initiation of a normal service request procedure (for example, a normal RRC Connection Setup procedure).

The value for the timer can in various embodiments be a common value throughout the cell which is broadcast by the network in system information. Additionally or alternatively the value could in other embodiments be conveyed to the UEs in dedicated signaling, and/or it may be predefined according to a published wireless specification and known to the eNB and UE in advance.

The context validity area indicates the area in which the stored UE context is valid. For example, the network can indicate to the UE the cell, frequency band, specific component carrier, specific frequency, tracking area, roaming area or local area in which the UE context is valid. Additionally or alternatively the network can indicate the UE context is valid always and everywhere with a context fetch command or request. If the UE moves out from the signalled context validity area the UE can inform the network via signalling about the movement outside the designated context validity area. In one non-limiting embodiment this could be achieved for example by the UE initiating the context release procedure from the mobility management entity (MME) towards the network if the UE moves to a new tracking area. In this case the network can then delete the context, but regardless the UE does not use the RRC Resume procedure outside the context validity area (unless/until it gets a new UE context that is valid for its new area) so the UE and the network can release, suspend, delete or otherwise stop using the stored context once the UE signals it has moved outside the context validity area. As another example of informing the network the UE has moved outside the validity area, if the validity area is the UE's tracking area the UE can inform the old area immediately prior to (or after) it sends its tracking area update message to the new area. Alternatively, the UE can dispense with this additional message to the old area and simply discontinue using the old context once it has left the validity area, and eventually the timer will expire anyway.

When the UE wishes to resume a RRC connection using a stored UE context, in certain embodiments the UE will indicate to the network that it has a stored UE context available only when certain conditions are met. These conditions may also be referred to as validity criteria. For example, such conditions can be that the UE is operating in the specific context validity area that was previously indicated by the network (for example within the indicated cell, band, carrier, frequency, tracking area, roaming area, local area). Another condition may be radio conditions, for example there must be a minimum signal power and/or signal quality. A further condition may be a minimum coverage enhancement (CE) level. CE levels are known in the wireless art and generally refer to levels of additional effort or of adaptation of certain radio parameters to keep radio contact with certain radio devices located in areas of poor coverage. Any combination of these conditions can be the condition(s) precedent to the UE storing its UE context.

Certain behaviors of the UE and/or network according to these embodiments can be specified in a published radio standard/specification. For example, such radio specifications can mandate that this new context validity time and context validity area information are added in the RRC Connection Release message for suspending the RRC connection. For the case that there is a new RRC message introduced for the RRC connection suspension procedure, this context validity related information could be added to that new RRC message. Additionally or alternatively, such radio specifications can stipulate that the context validity time and context validity area information are to be added in broadcast system information which is common for all the UEs operating under this cell. As mentioned above, in various examples this context validity area information could be cell, band, carrier, frequency, tracking area, roaming area, local area or even always/everywhere for which the UE context can be made available everywhere/always with a context fetch command or request.

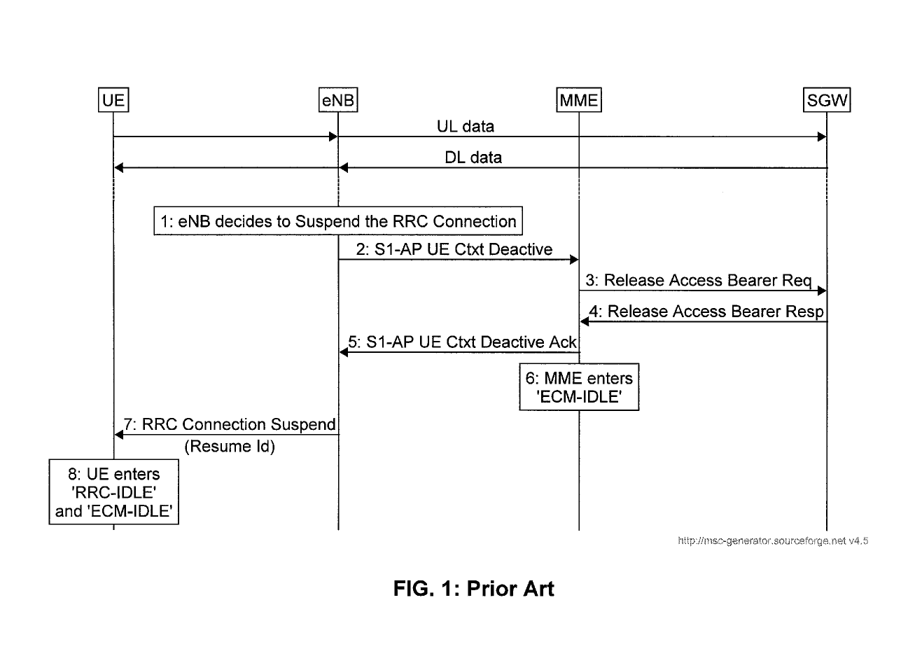

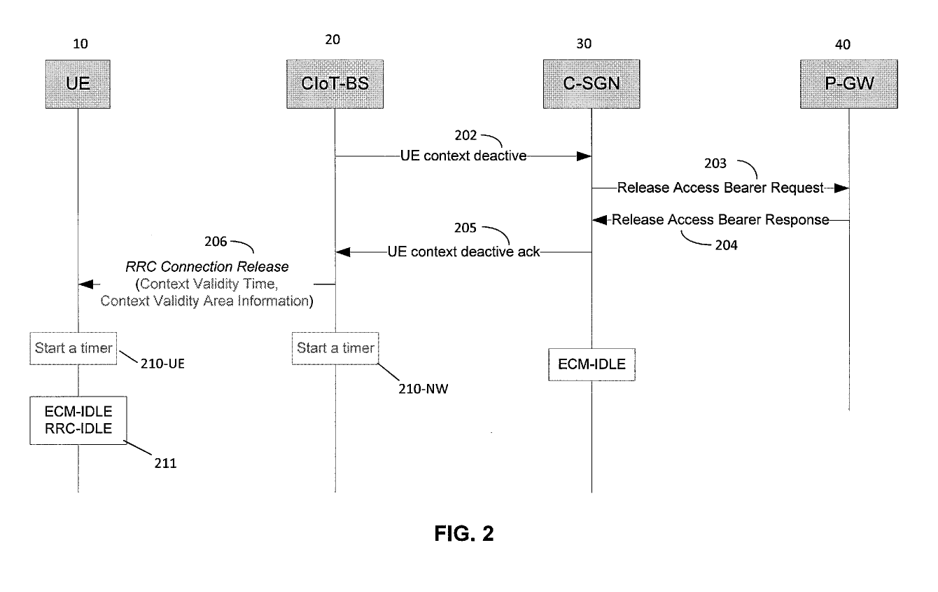

FIG. 2 is a non-limiting example of a signaling diagram between the UE 10, the CIoT base station (CIoT-BS) 20, the cellular serving gateway (C-SGN) 30 and the packet gateway (P-GW) 40. Prior to what is shown t FIG. 2 the UE 10 establishes a RRC connection with the network/CIoT-BS 20 for which there is a valid UE context. Similar to step 1 of FIG. 1 the network decides to suspend that RRC connection and sends a UE context deactivate message 202 to the C-SGN 30 similar to message 2 in FIG. 1 between the eNB and the MME. The C-SGN 30 then sends a Release Access Bearer request 203 to the P-GW 40, which responds with a Release Access Bearer response message 204. Upon receipt of this response message 204 the C-SGN 30 then acknowledges 205 to the CIoT-BS 20 that the UE context is deactivated.

That acknowledgement 205 triggers the CIoT-BS 20 to send to the UE 10 a RRC connection release message 206. If the value for the context validity timer and the information about the context validity area were not provided already (such as via system information), the RRC connection release message 206 may carry this information to the UE 10. This message 206 triggers the UE 10 to start its context validity timer 201-UE as well as the CIoT-BS 20 to start its own local context validity timer 210-NW, and while these timers 201-UE/210-NW are running these respective entities store the UE's context in their local memory (unless some other event mentioned above allows them to delete it, such as the UE moving out of the designated context validity area). With the timer started the UE 10 then enters the RRC IDLE mode or state 211 which may also be considered an ECM IDLE mode. If there is any downlink data to the UE 10 the C-SGN 30 also is aware the UE 10 is in the RRC IDLE or ECM IDLE mode as FIG. 2 illustrates, and so the RRC connection can be resumes using the stored UE context regardless of whether the new data is to be sent from the UE 10 on the uplink or to the UE 10 on the downlink

The UE 10 may apply the context validity time value for a timer, which is started upon dedicated signaling from the network such as via RRC connection suspend, RRC connection resume, RRC connection reconfiguration, RRC connection setup, and/or RRC connection release signaling (for example, either new RRC signaling or a new indication added to conventional RRC signaling). This timer may also be started upon a data transmission to or from the UE, including a successful data transmission, a data transmission via the user plane, and/or a data transmission via the control plane. When the timer is initiated the UE stores its UE context for the RRC connection that corresponds to that dedicated signaling or data transmission.

The UE 10 may stop this context validity timer based on broadcast and/or dedicated signaling from the network, based on initiation of the control plane solution, and/or based on the normal service request (RRC connection establishment) procedure.

The UE 10 may release, suspend, delete or otherwise stop using that stored AS context upon the expiration of this timer, or upon moving out from the signaled context validity area, whichever occurs first.

The UE 10 could determine whether to perform the normal RRC connection setup procedure (service request) or to perform the RRC resume procedure whenever the UE 10 has uplink data to send based on the availability of the UE context. If there is no valid UE context (for example, if the timer has expired or if the UE is no longer within the context validity area) the UE will made a service request by performing a (conventional) RRC Connection Setup procedure. If there is a valid UE context (the UE context is stored, the timer has not yet expired and the UE is within the context validity area) the UE 10 will use that stored UE context to perform the RRC Resume type procedure, and in that procedure the UE 10 will indicate the context availability to the network/CIoT-BS 20 via physical layer (PHY), media access control layer (MAC), radio resource control (RRC) and/or network access stratum (NAS) signaling.

Certain embodiments of these teachings, and specifically those that adapt the Solution 18 mentioned in the background section above, provide the technical effect of optimizing the handling of UE context in both the UE 10 and in the network/CIoT-BS 20. Based on the AS context management approaches according to these teachings, the context validity could be synchronized between UE and the network/eNB, and therefore an appropriate signaling procedure could be initiated to avoid an unnecessary signaling exchange that would otherwise be required if there is any misalignment between the UE and the network about the context availability. A further technical effect is that embodiments of these teachings enable the network (eNB; CIoT-BS) to manage its memory in an optimal way and thereby increase the number of UEs it can support.

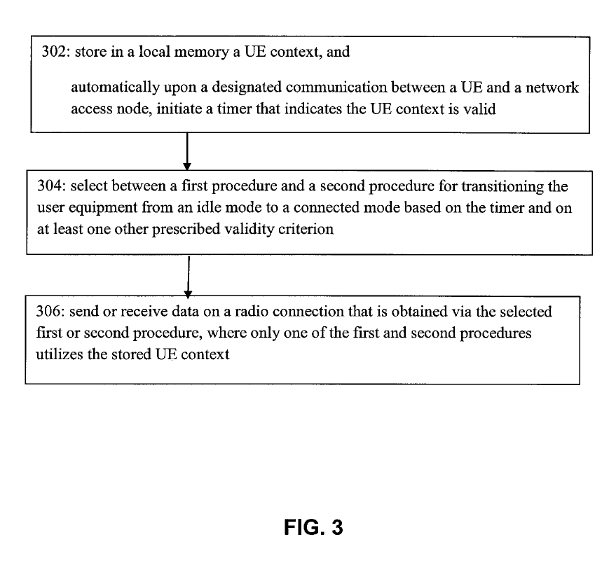

FIG. 3 is a process flow diagram that summarizes some of the above aspects from the perspective of both the UE 10 and of a network access node such as the CIoT-BS 20 of FIG. 2. Block 302 of FIG. 3 begins with the step of storing in a local memory at least a UE context and automatically upon a designated communication between a user equipment and a network access node initiating a timer that indicates the UE context is valid. In this regard, if the UE is performing the process of FIG. 3 the context is stored in the UE's local memory, and similarly if the network access node is performing it then the UE's context is stored in the access node's local memory.

FIG. 3 continues at block 304 in which the communication device performing this method selects between a first procedure and a second procedure for transitioning the user equipment from an idle mode to a connected mode, and this selection is based on the timer being valid and also on whether at least one other prescribed validity criterion is satisfied.

FIG. 3 concludes with the communication device sending or receiving (user) data on a radio connection that is obtained via the selected first or second procedure, where only one of the first and second procedures utilizes the stored UE context.

In one particular embodiment of FIG. 3 the first procedure is a Radio Resource Control (RRC) connection resume procedure and is selected when the timer is not expired and the at least one prescribed validity criterion is satisifed; while the second procedure is a RRC connection setup procedure during which a new UE context for the user equipment is established.

In this or other embodiments the at least one other prescribed validity criterion is that the UE is operating within a designated context validity area, and/or it is at least one minimum radio condition, and/or it is at least a minimum CE level.

In the examples above the timer is a context validity timer, and a value for the context validity timer and the designated context validity area are communicated to the UE via broadcast or dedicated signaling.

The designated communication mentioned at block 302 can be for example any of a RRC connection suspend message; a RRC connection resume message; a RRC connection reconfiguration message; a RRC connection setup message; a RRC connection release message; and user data. The UE and the CIoT-BS may use the second procedure regardless of the timer and the at least one other prescribed validity criterion when the selecting of block 304 is overridden by (broadcast or dedicated) signaling from the network access node to not use the stored UE context.

For the case that it is the UE performing the steps of FIG. 3 and the UE selects the first procedure based on the timer being not expired and the at least one other prescribed validity criterion being satisfied, the first procedure comprises the UE indicating to the CIoT-BS that the stored UE context is valid. For the opposite case where it is the CIoT-BS performing the steps of FIG. 3 and the CIoT-BS selects the first procedure based on the timer being not expired and the at least one other prescribed validity criterion being satisfied (for example, where the RRC connection is resumed because the network has downlink data for the UE), the first procedure comprises the CIoT-BS receiving from the UE an indication that the stored UE context is valid.

Several of these aspects concerning FIG. 3 may be practiced individually or in any of various combinations.

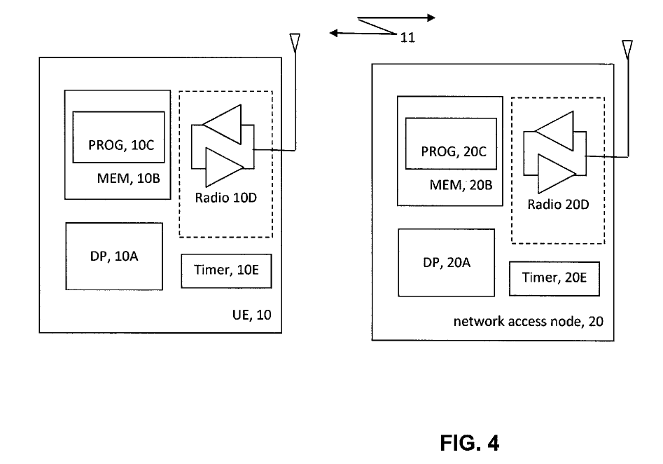

FIG. 4 is a schematic diagram illustrating some components of the network access node 20 and the UE 10 shown at FIG. 2 as the UE 10 and the CIoT-BS 20. In the wireless system/cell a wireless network is adapted for communication over a wireless link 11 with an apparatus such as a mobile communication device which may be referred to as a UE 10, via a radio network access node such as a Node B (base station), and more specifically an eNB 20 that may be operating specifically for this UE 10 as a CIoT-BS. The network may include a network control element (NCE, not shown) that may include mobility management entity/serving gateway (MME/S-GW) functionality, and which provides connectivity with a further network such as a telephone network and/or a data communications network (e.g., the internet).

The UE 10 includes a controller, such as a computer or a data processor (DP) 10D, a computer-readable memory medium embodied as a memory (MEM) 10B that stores a program of computer instructions (PROG) 10C, and a suitable wireless interface, such as radio frequency (RF) transmitter/receiver combination 10D for bidirectional wireless communications with the eNB 20 via one or more antennas. The timer 10F is shown separately but in some embodiments may be implemented as software or as part of the DP 10A itself.

The wireless link between the UE 10 and the remote UE(s) can be checked for link quality by comparing a measurement of it (for example, received signal strength or quality) against some minimum threshold before determining to use the stored context, if radio conditions is/are one or more of the validity criteria.

The network access node 20 also includes a controller, such as a computer or a data processor (DP) 20A, a computer-readable memory medium embodied as a memory (MEM) 20B that stores a program of computer instructions (PROG) 20C, and a suitable wireless interface, such as RF transmitter/receiver combination 20D for communication with the UE 10 (as well as other UEs) via one or more antennas. The network access node 20 has its own timer 20E that runs synchronous with that of the UE 10, though both are started and stopped based on common external events as described above by example rather than being synchronized to one another directly. The network access node 20 is coupled via a data/control path (not shown) to the NCE and this path may be implemented as an interface. The network access node 20 may also be coupled to another network access node/eNB via another data/control path, which may be implemented as a different interface.

At least one of the PROGs 10C/20C is assumed to include program instructions that, when executed by the associated DP 10A/20A, enable the device to operate in accordance with exemplary embodiments of this invention as detailed above. That is, various exemplary embodiments of this invention may be implemented at least in part by computer software executable by the DP 10A of the UE 10; by the DP 20A of the network access node 20, or by hardware or by a combination of software and hardware (and firmware).

In various exemplary embodiments the UE 10 and/or the network access node 20 may also include dedicated processors, for example a RRC module, a RF front end, and the like. There may also be one or more modules that is/are constructed so as to operate in accordance with various exemplary embodiments of these teachings.

The computer readable MEMs 10B/20B may be of any type suitable to the local technical environment and may be implemented using any one or more suitable data storage technology, such as semiconductor based memory devices, flash memory, magnetic memory devices and systems, optical memory devices and systems, fixed memory and removable memory, electromagnetic, infrared, or semiconductor systems. Following is a non-exhaustive list of more specific examples of the computer readable storage medium/memory: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

The DPs 10A/20A may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., the radios 10D/20D) may be of any type suitable to the local technical environment and may be implemented using any suitable communication technology such as individual transmitters, receivers, transceivers or a combination of such components.

In general, the various embodiments of the UE 10 can include, but are not limited to, smart phones, machine-to-machine (M2M) communication devices, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions. Any of these may be embodied as a hand-portable device, a wearable device, a device that is implanted in whole or in part, a vehicle- or fixedly-mounted communication device, and the like.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into an embodiment that is not specifically detailed herein as separate from the others. Accordingly, the description is intended to embrace all such alternatives, modifications and variances which fall within the scope of the appended claims.

1-33. (canceled)

34. A method comprising:
storing in a local memory a user equipment (UE) context of a UE;
initiating a procedure for transitioning the UE from an enhanced idle mode during which the UE context is retained to a connected mode based on at least one prescribed validity criterion, wherein the at least one prescribed validity criterion comprises that the UE is operating within a designated context validity area; and thereafter
sending or receiving data on a radio connection that is obtained via the said procedure, where the said procedure utilizes the stored UE context.

35. The method according to claim 34, wherein the designated context validity area indicates an area in which the stored UE context is valid.

36. The method according to claim 34, wherein the at least one prescribed validity criterion further comprises a timer that indicates the stored UE context is valid.

37. The method according to claim 36, wherein the said procedure is selected from one of a Radio Resource Control (RRC) connection resume procedure and a RRC connection setup procedure.

38. The method according to claim 37, wherein the RRC connection resume procedure is selected when the timer is not expired and the at least one prescribed validity criterion is satisfied; and the RRC connection setup procedure is otherwise selected during which a new UE context for the user equipment is established.

39. The method according to claim 36, wherein:
the timer is a context validity timer, and
a value for the context validity timer and the designated context validity area are communicated to the UE via broadcast or dedicated signaling.

40. The method according to claim 36, wherein the timer is initiated automatically upon a designated communication between a user equipment and a network access node; and the designated communication between the user equipment and the network access node comprises any of:
a RRC connection suspend message;
a RRC connection resume message;
a RRC connection reconfiguration message;
a RRC connection setup message;
a RRC connection release message; or
user data.

41. An apparatus comprising:
at least one memory storing a computer readable program; and
at least one processor,
wherein the at least one processor, with the at least one memory and the computer readable program, cause the apparatus to at least:
store in the at least one memory a user equipment (UE) context of a UE;
initiate a procedure for transitioning the user equipment from an enhanced idle mode during which the UE context is retained to a connected mode based on at least one prescribed validity criterion, wherein the at least one prescribed validity criterion comprises that the UE is operating within a designated context validity area; and thereafter
send or receive data on a radio connection that is obtained via the said procedure, where the said procedure utilizes the stored UE context.

42. The apparatus according to claim 41, wherein the designated context validity area indicates an area in which the stored UE context is valid.

43. The apparatus according to claim 41, wherein the at least one prescribed validity criterion further comprises a timer that indicates the stored UE context is valid.

44. The apparatus according to claim 43, wherein:
the timer is a context validity timer, and
a value for the context validity timer and the designated context validity area are communicated to the UE via broadcast or dedicated signaling.

45. The apparatus according to claim 43, wherein the timer is initiated automatically upon a designated communication between a user equipment and a network access node; the designated communication between the user equipment and the network access node comprises any of:
a RRC connection suspend message;
a RRC connection resume message;
a RRC connection reconfiguration message;
a RRC connection setup message;
a RRC connection release message; or
user data.

46. The apparatus according to claim 43, wherein the said procedure is selected from one of a Radio Resource Control (RRC) connection resume procedure and a RRC connection setup procedure.

47. The apparatus according to claim 46, wherein the RRC connection resume procedure is selected when the timer is not expired and the at least one prescribed validity criterion is satisfied; and the RRC connection setup procedure is otherwise selected during which a new UE context for the user equipment is established.

48. The apparatus according to claim 46, wherein the RRC connection setup procedure is selected regardless of the timer and the at least one prescribed validity criterion when the selecting is overridden by signaling from the network access node to not use the stored UE context.

49. The apparatus according to claim 46, wherein the apparatus is the UE, the network access node is a cellular Internet of Things base station (CIoT-BS), and for the case the UE selects the Radio Resource Control (RRC) connection resume procedure based on the timer being not expired and the at least one prescribed validity criterion being satisfied, the Radio Resource Control (RRC) connection resume procedure comprises the UE indicating to the CIoT-BS that the stored UE context is valid.

50. The apparatus according to claim 46, wherein the apparatus is the network access node which is a cellular Internet of Things base station (CIoT-BS), and for the case the CIoT-BS selects the Radio Resource Control (RRC) connection resume procedure based on the timer being not expired and the at least one prescribed validity criterion being satisfied, the Radio Resource Control (RRC) connection resume procedure comprises the CIoT-BS receiving from the UE an indication that the stored UE context is valid.

51. The apparatus according to claim 41, wherein the at least one prescribed validity criterion comprises at least one minimum radio condition, and/or at least a minimum coverage enhancement level.

52. An apparatus, comprising at least one memory storing a computer readable program; and
at least one processor, wherein the at least one processor, with the at least one memory and the computer readable program, cause the apparatus to at least:
send a radio resource connection signaling for suspending a radio connection;
store in a local memory a user equipment (UE) context;
wherein the said radio resource connection signaling comprising at least context validity area.

53. The apparatus according to claim 52, wherein the said radio resource connection signaling comprises a radio resource connection release signaling.
